(19) United States
(12) Patent Application Publication
(10) Pub. No.: US 2002/0188570 A1
(43) Pub. Date: Dec. 12, 2002

(54) PARTIAL PROTECTION OF CONTENT

(75) Inventors: MATTHEW J. HOLLIMAN, LIBERTYVILLE, IL (US); BOON-LOCK YEO, SUNNYVALE, CA (US); ROBERT G. LIU, SUNNYVALE, CA (US); MINERVA MING-YEE YEUNG, SUNNYVALE, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: Donna Jo Coningsby

(21) Appl. No.: 09/275,514

(22) Filed: Mar. 24, 1999

(51) Int. Cl. G06F 17/60

(52) U.S. Cl. 705/57

(57) ABSTRACT

In some embodiments, the invention includes a method of providing content including selecting a set of segments of content from a group of segments to be protected. The segments of the set are protected with protection that can be undone. The group of segments are transmitted. In other embodiments, the invention includes a method of receiving and processing content including receiving a group of segments of content. The set of segments in the group that are protected are identified. The protection is undone. The group of segments is played seamlessly with a media player. Additional embodiments are described and claimed.

### BACKGROUND OF THE INVENTION

1. Technical Field of the Invention

The invention relates to partially protecting content such as multimedia content to be provided to remote computers, only some of which will have the ability and permission to undo the partial protection and produce the entire content remotely.

2. Background Art

With the advent of digital media and the increasingly widespread use of the Internet, cable, and satellite transmissions, the amount of content creation is dramatically increasing. Examples of content include video images and still images, with or without audio, and audio alone. Content may be created for commercial purposes such as entertainment and advertising, or for more personal interests such as home movies and information for the hobbyist. Examples of entertainment include movies which are available on DVD (digital video disks) in one of the MPEG (moving picture expert group) formats.

Content providers may want different persons to have access to different portions of the content. Currently, that involves sending different persons different content. For example, a person may want to make video images available on a Web site. The person may want some pictures to be available for anyone who is interested, while making others of the pictures available for viewing by only for only some people. To accomplish this, the person would post two sets of video images, one set that was freely available and the other set that would be available through access of a password to the Web site and/or through remote decryption. Creation of the two sets of images may involve video editing by the content provider and other additional steps by the person controlling the Web site and the person accessing the Web site remotely.

For many content providers, there is the additional concern that sensitive or economically valuable content be provided only to specific individuals. Passwords and encryption have been used in an attempt to assure this. For example, an Internet provider may require a password to provide content and/or encrypt the content and expect the receiver to decrypt the content. However, once the content is on the remote computer, it can be transferred to another computer to be available for someone else.

The present invention involves solutions to these and other problems.

### SUMMARY

In some embodiments, the invention includes a method of providing content including selecting a set of segments of content from a group of segments to be protected. The segments of the set are protected with protection that can be undone. The group of segments are transmitted.

In other embodiments, the invention includes a method of receiving and processing content including receiving a group of segments of content. The set of segments in the group that are protected are identified. The protection is undone. The group of segments is played seamlessly with a media player.

Additional embodiments are described and claimed.

### BRIEF DESCRIPTION OF THE DRAWINGS

The invention will be understood more filly from the detailed description given below and from the accompanying drawings of embodiments of the invention which, however, should not be taken to limit the invention to the specific embodiments described, but are for explanation and understanding only.

FIG. 1 is a schematic representation of a system including a content providing system, a link, and remote receiving computers according to some embodiments of the invention.

FIG. 2 graphically illustrates different segments of a video signal.

FIG. 3 illustrates a graphical user interface in a screen to perform authoring on the segments of FIG. 2 to selectively protect some of the segments through encryption and/or visual scrambling according to some embodiments.

FIG. 4 is a schematic representation of a content providing system according to some embodiment of the invention.

FIG. 5 is a schematic representation of a system including a content providing system, a disc writer device, and a remote receiving computer according to some embodiments.

FIG. 6 is a schematic representation of visual scrambler and encryption mechanisms in the content providing system of FIGS. 1 and 4 according to some embodiments.

FIG. 7 is a schematic representation of decryption and visual descrambling mechanisms in a media player of a remote receiving computer according to some embodiments.

FIG. 8 is a diagram illustrating blocks of first and second macroblocks of an image in the spatial domain that may be used in connection with some embodiments of the invention.

FIG. 9 is a block diagram representation of an encoder for creating an MPEG bitstream from spatial domain blocks that may be used in connection with some embodiments of the invention.

FIG. 10 is a diagram illustrating an MPEG bitstream including headers and coefficients for the first and second macroblocks of FIG. 8 that may be used in connection with some embodiments of the invention.

FIG. 11 is a block diagram representation of a scrambling computer, a link, and a remote computer, which may be a descrambling computer.

FIG. 12 is a block diagram representation of a scrambling encoder used in coefficient scrambling according to some embodiments of the invention.

FIG. 13 is a block diagram representation of a mechanism for selecting the coefficient to alter in FIG. 10 according to some embodiments of the invention.

FIG. 14 is a block diagram representation of a descrambling decoder used in coefficient descrambling according to some embodiments of the invention.

FIG. 15 is a block diagram representation of a scrambling encoder used in scrambling of video images according to some embodiments of the invention.

FIG. 16 is a block diagram representation of a descrambling decoder used in descrambling of video images according to some embodiments of the invention.

FIG. 17 is a flow chart representing permutational scrambling of digital images according to some embodiments of the invention.

FIG. 18 is a flow chart representing permutational descrambling of digital images according to some embodiments of the invention.

FIG. 19 is a block diagram representation of a mechanism for selecting the permuted order for blocks in some embodiments of the invention.

FIG. 20 is a block diagram representation of a mechanism for selecting the original order for blocks in some embodiments of the invention.

### DETAILED DESCRIPTION

The invention concerns partially protecting content to be provided to remote computers, only some of which will have the ability and permission to undo the partial protection and produce the entire content remotely. There are a variety of reasons to partial protect content and allow restricted undoing of the protection. For example, under one use, the invention includes placing vacation videos on the World Wide Web, but protecting some segments, such as those showing children. Then, certain family members or friends can see all segments, while other members of the public can see only the undo protection of segments.

Another use includes placing an entire movie on a disc (such as a DVD) but protecting certain segments of the movie. Access to these segments would be available with the correct key including a password. Under one scenario, the protected segments include subject matter which some parents might not want their young children to view. The password could be included on a piece of paper included with the disc. Persons knowing the password could watch the entire movie, while others would watch only the undo protection of segments. Under another scheme, clips (teasers) for the movie could be undo protection of segments, while the movie itself would be protected. A user could obtain the password for a fee. There may be two levels of passwords. One level allows the person to see the entire video and another allows to see only certain scenes.

The invention may also be used in a streaming video environment such as over a cable network or the Internet. On the fly encoding in the content providing system and decoding in the remote computer allow streaming content.

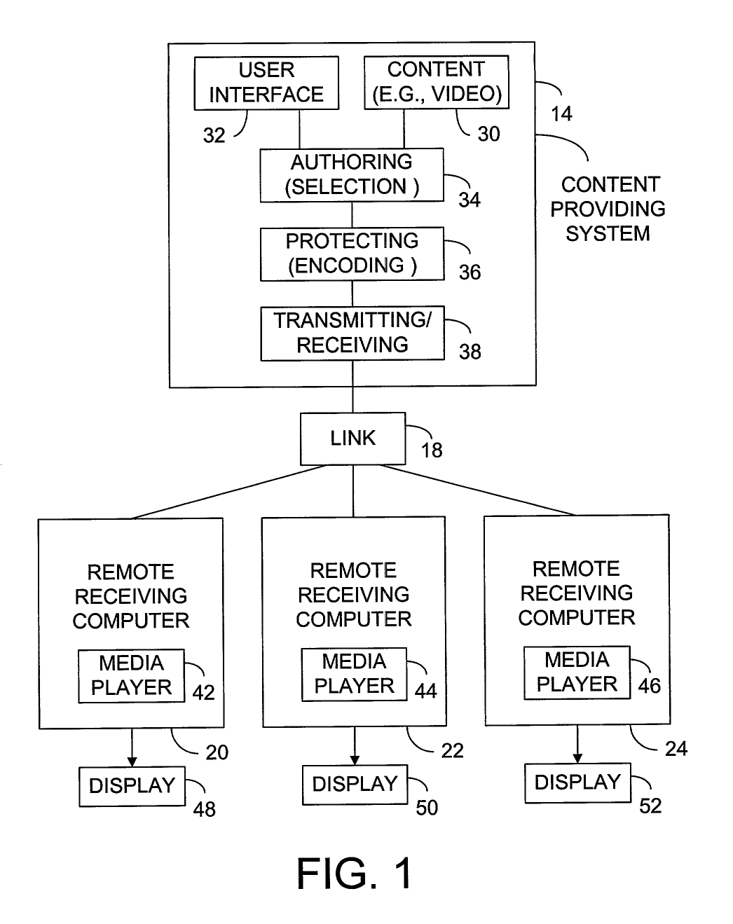

Referring to FIG. 1, a content providing system 14 provides partially protected content through a link 18 to multiple receiving computers, of which remote receiving computers 20, 22, and 24 are examples. Displays 48, 50, and 52 may be physically integrated with or separate from remote receiving computers 20, 22, and 24. Link 18 represents any of various links including the Internet, an intranet, a local area network, a satellite network, or other networks. (As described below, the partially protected content may also be transferred on a machine readable medium such as a disc.) Examples of protection include visual scrambling and bit encryption. Content providing system 14 includes a computer or computers. As used herein, the term computer is intended to be broadly interpreted to include a variety of systems and devices including personal computers, mainframe computers, set top boxes, digital versatile disc (DVD) players, and the like. Content providing system 14 includes content 30 which may be stored in system 14 in various forms. Examples of content include video images, still images, and graphics, each with or without audio. The video is not restricted to any particular format. It may be one of the MPEG formats.

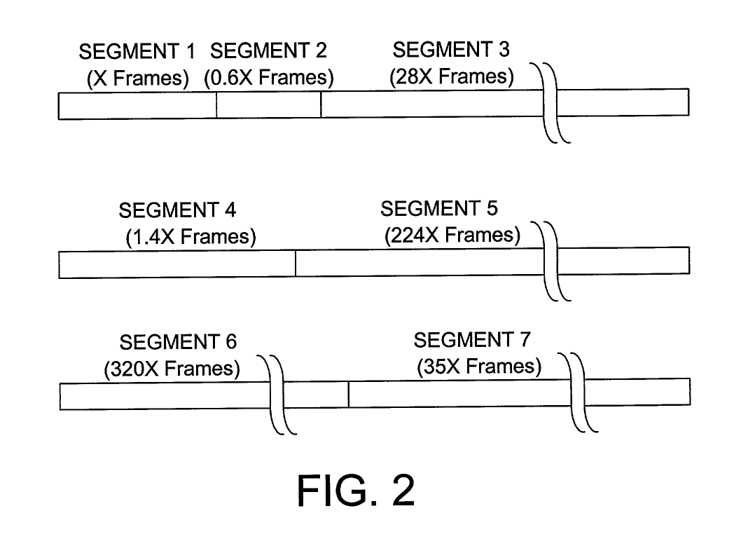

In the specific illustrated example, content 30 includes a group of segments (which may be called shots in the case of video). For example, FIG. 2 illustrates exemplary segments 1-7, each having a different number of frames. The seven segments form a group. The segments may be sequential segments created from a previously continuous source (such as a continuous video signal) or from previously disconnected sources (such as joining together previously disjointed video shots).

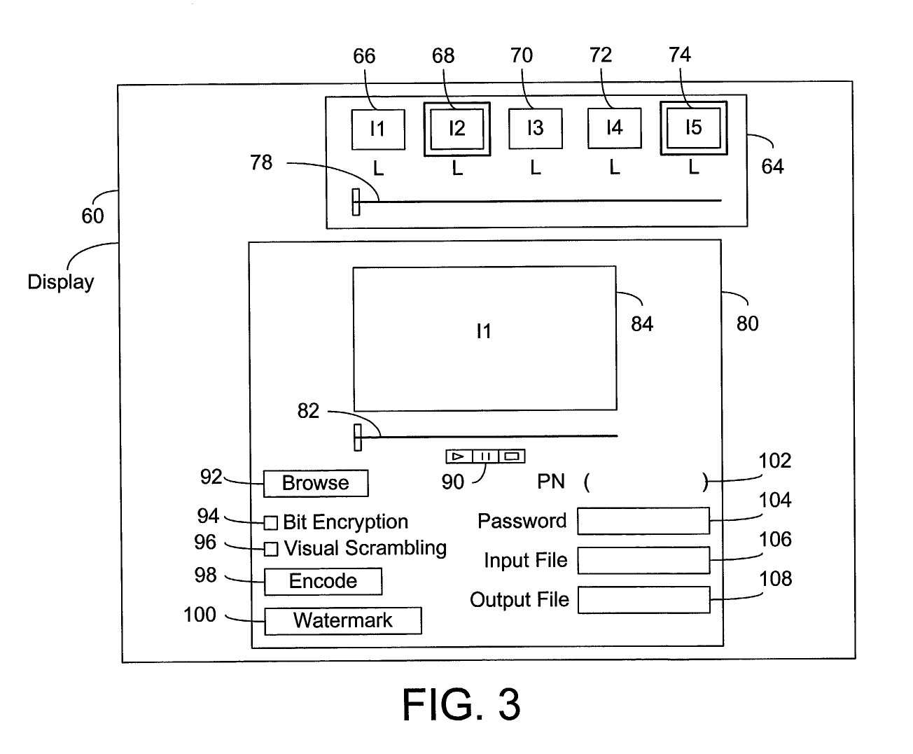

Referring to FIGS. 1-3, a user interface 32 and authoring mechanism 34 are used to select at least one (a set) of the segments of content 30 to be protected. Authoring refers to selecting a segment for protection. User interface 32 may include a keyboard, mouse, and a graphical user interface (GUI) on a display. The GUI may be represented in a variety of forms and include a variety of information. For example, referring to FIG. 3, a GUI presented on a display 60 includes the following information and options, but not all these are required and other information and options could be included. Display 60 includes a window 64 that displays images from the segments in displays 66, 68, 70, 72, and 74. The images displayed may be the first frame of each segment. For example, image II represents the first frame of segment 1, image I2 represents the first frame of segment 2, etc. of FIG. 2. In display 64, only five of the segments of the group are displayed at a time. A scroll bar 78 can be used to select which five of the segments are represented in displays 66-74. For example, as the scroll bar moves to the right, the image 15 may be moved to where 14 was, and image 14 may move to where image 13 was, etc., and an image for the first frame of segment 6 appears where image 15 was. The symbol “L” below displays 66-74 represents the length of each displayed segment. The length of the segments may be measured in time duration and/or number of frames. Also the length (in time duration and/or number of frames) from the first frame of the first slot may be calculated.

A window 80 includes a display 84 for displaying one of the segments, which may be selected, paused or stopped through icons 90 or other means. A scroll bar 82 may be used to advance through frames of the segment selected for viewing in display 84. The various icons described herein can be activated through a mouse. Activation of a browse icon 92 may cause segment in display 66 to also appear in display 84. Bit encryption and visual scrambling selection boxes 94 and 96 can be checked with a click of a mouse to select bit encryption and/or visual scrambling features described below. In some embodiments, when either of these boxes is checked, the corresponding display in window 64 is enclosed in a rectangle or otherwise designated as being protected. The protection occurs in response to encode icon 98 being activated with a click of a mouse. For example, display 68 and 74 are enclosed in a rectangle indicating that segments 2 and 5 (which include images 12 and 15) will be protected if encode icon 98 is activated.

There are at least two ways in which a RCN (e.g., a PN) may be used. In some embodiments, the RCN is used as a component of a key. In other embodiments, the RCN is in a table stored in the scrambling computer and is matched against the remote RCN during playback. This second way may be useful where the content is target to multiple users.

In the above described system, the default condition is to not protect segments and the user has to do something (e.g., check box 94 and/or 96) to select them for protection. In essence, the other segments are selected to be not protected by the failure to select them to be protected. Under an alternative system, the default condition may be to protect segments and the user has to do something to select them to not be protect. Under still another system, a user may have to designate whether a segment is to be protected or not protected.

In some embodiments, a remote computer number (RCN) is used as part of a key to protect the segments (e.g., with bit encrypting and/or visual scrambling). The remote computer number is number associated with a remote computer and is used to undo the protection remotely. Examples of remote computer number include a processor number (PN) associated with a particular processor, a chipset number associated with a particular chipset, and a software number that is associated with particular software, such as an operating system, or a combination of them. In the example of FIG. 3, the remote computer number is a processor number (PN) 102 displayed between the parenthesis. If this PN feature is included in the key, the remote receiving computer will need a processor having a processor number that matches the processor number selected. Otherwise, decoding will not occur and the protected segments will remain protected.

Password box 104, Input File box 106, and Output File box 108 allow typing of passwords, and designations for the input and output files of the segments. Other means may be used for providing the password and input and output files. A password is used for encoding (bit encryption and/or visual scrambling) the segments selected for protection. The same password is used in the remote receiving computer to undo the protection of the protected segment.

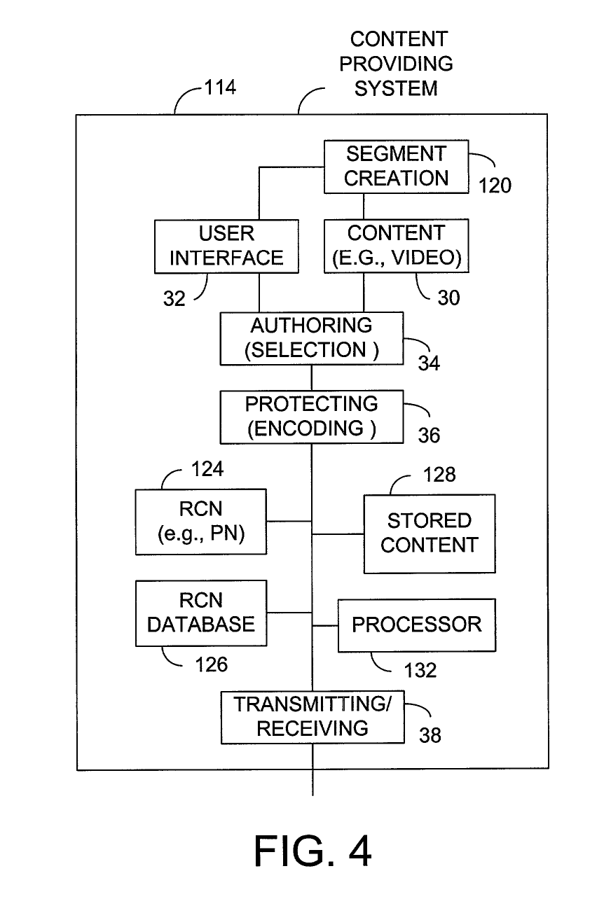

FIG. 4 illustrates a content providing system 114 which is similar to content providing system 14 but illustrates some additional capabilities, which could be included in content providing system 14. A segment creation mechanism 120 represents a user interface and associated software to select segments of the group of segments (e.g., to designate the beginning and ending frames or time of the segment). Mechanism 102 may be used for joining disjointed segments in a group and/or dividing continuous content into segments of a group.

The remote computer number (RCN) mechanism 124 represents software to obtain a remote computer number of the remote receiving computer (e.g., computer 20). The remote computer number can be obtained in various ways (e.g., through a secure socket layer applet sent to the remote receiving computer). The user of the remote receiving computer could request software that is downloaded from content providing system 114. Upon receiving the correct password, the software interfaces with content providing system 114 to obtain the remote computer number of the remote receiving computer, which may be stored in a RCN database 126 so the remote computer number does not have to be obtained again. Passwords may also be stored. Protected content may be stored in stored content memory 128. There may be different stored contents for different combinations of remote computer numbers and passwords. As noted, the invention does not require a remote computer number. The various mechanisms described herein may be implemented in hardware or through software or firmware run on a processor 132.

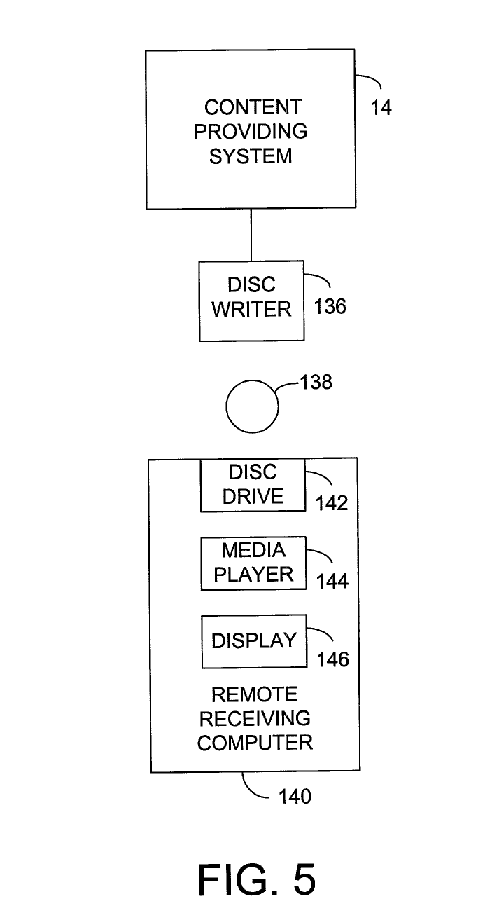

Referring to FIG. 5, the invention is not limited to use with a physical link. Rather, the group of segments may be written by a disc writer 136 onto a disc 138. Which is inserted into a disc drive 142 of a remote receiving computer 140. Assuming remote receiving computer 140 has the correct key, media player 144 undoes the protection of the set of segments, and the entire group of segments may be displayed on display 146.

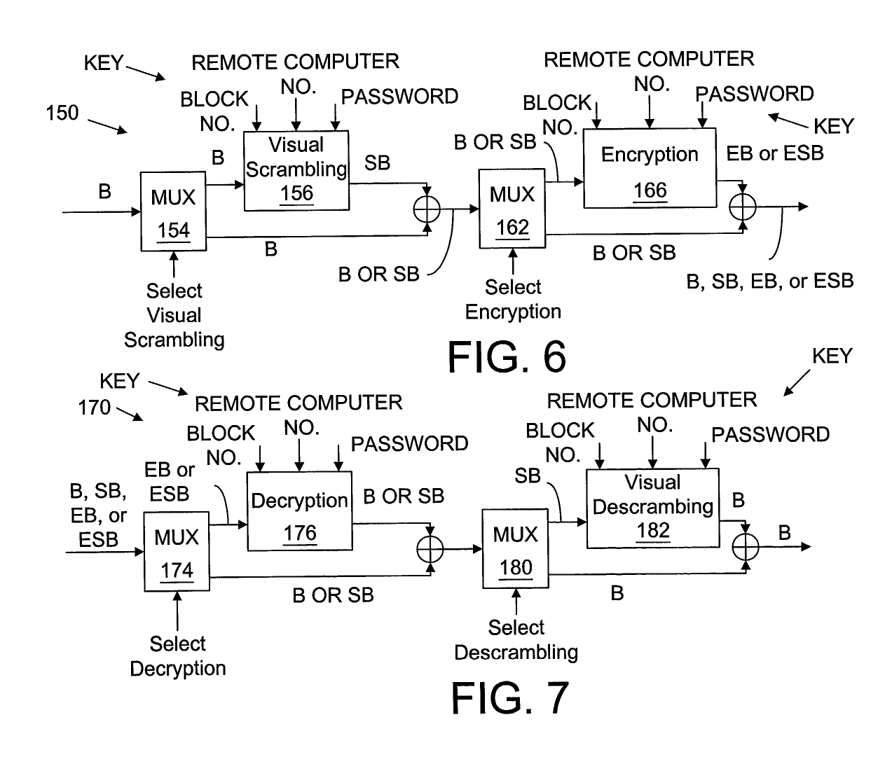

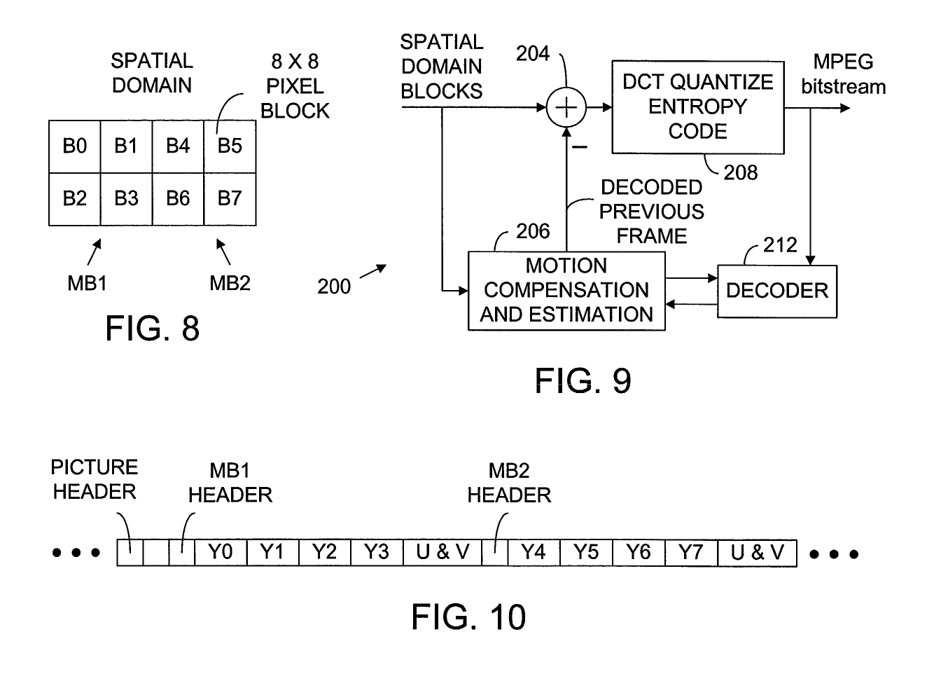

FIGS. 6 and 7 illustrates the encoding (protecting) and decoding (undoing of the protection) according to some embodiments. The invention is not limited to the particular details. For example, in some embodiments, only bit encryption is used and in others embodiments, only visual scrambling is used. In still other embodiments, another type of protection may be used. Referring to FIGS. 1 and 6, protecting mechanism 36 in FIG. 1 includes an encoder 150 that receives, for example, a block B of undo protection of video from the segment. The block B may be an 8×8 discrete cosine transform (DCT) block, which is discussed in greater detail in connection with FIGS. 8-10, below. If visual scrambling is selected in MUX 154, block B is passed to visual scrambling mechanism 156. The block is visual scrambled in response to a key (which may include a block number, a remote computer number, and/or a password). The key may include different components. The same key is used in descrambling, described in connection with FIG. 7. Scrambling may include various levels of degradation. Details regarding visual scrambling are described below.

The scrambled block SB or block B (if visual scrambling is not selected) is passed to a MUX 162, where bit encryption may be selected in encryption mechanism 166. Various forms of encryption may be used. Symmetric key or public/private key encryption may be used. A key may include a password, remote computer number, and/or block number. These may be hashed separately and concatenated or, for example, truncated, concatenated, and hashed. A difference between visual scrambling and bit encryption is as follows. Visual scrambling retains some semblance of video format. For example, the MPEG header information may be correct, although the quotients are altered. With bit encryption, the encrypted signal may be unrecognizable as a video image. The block B, scrambled block SB, encrypted block EB, or encrypted scrambled block ESB are provided to transmitting/receiving block 38 for transmission to remote computers or to the disc writer.

FIG. 7 illustrates a decoder 170 in a remote receiving computer. If the block was encrypted, it may be selected for decryption at MUX 174. The selected decryption signal to MUX 174 may be obtained in response to header or other information (described below) and perhaps also the correct key. Decryption mechanism 176 decrypts the encrypted block EB or encrypted scrambled block ESB if the correct key is used. Likewise, descrambling may be selected at MUX 180 and the scrambled block SB be descrambled in visual descrambling mechanism 182, described in detail below.

Remote receiving computers 20, 22, and 24 include media players 42, 44, and 46 respectively, which represent three different types of media players. Media player 42 is a media player that has a decoder to undo protection of a protected set of segments. Media player 44 is a high quality media player that does not have the decoder to undo the protection. Media player 46 is a low quality media player that does not have a decoder to undo the protection.

If remote receiving computer 20 has the correct key, media player 42 undoes the protection and computer 20 displays the entire group of segments on display 48. If remote receiving computer 20 does not have the correct key (e.g., it does not have the correct password or processor number), it will not undo the protection. It will display undo protection of segments and probably display scrambled but unencrypted segments with visual degradation. In some embodiments, media player 42 has the ability to tolerate corrupted video segments (i.e., the protected segments) and not crash in the case when bit encryption is used. For instance, when the video is compressed using MPEG, media player 42 may be able to recover from invalid bit patterns and continue to parse the bit stream until the next legitimate header is found. This scenario does not require the use of the protected segment. Depending on details of media player 42 and details of the encrypted segments, media player 42 will skip over the encrypted segments or display them. If displayed, the images from encrypted segments may be unrecognizable.

If the correct key is used, media player 42 makes use of the protected segment and performs on-the-fly removal of the protected segment. This on-the-fly performance allows the video to be watched without having the entire video unprotected and left on storage. This ability is particularly valuable for streaming video applications.

Media player 44 of remote receiving computer 22 cannot undo protection of segments. It will display unprotected segments and probably display scrambled but unencrypted segments with visual degradation in display 50. Depending on details of media player 42 and details of encrypted segments, media player 44 will skip over the encrypted segments or display them. If displayed, the images from encrypted segments may be unrecognizable.

Media player 46 of remote receiving computer 24 cannot unprotect segments. It will display unprotected segments and probably display scrambled but unencrypted segments with visual degradation in display 52. Depending on details of media player 42 and details of encrypted segments, media player 44 will skip over the encrypted segments, display them, or crash. If displayed, the images from encrypted segments may be unrecognizable.

The following chart summarizes which of segments S1, S2, S3, S4, and S5 would appear on a display of some embodiments of remote receiving computers 20, 22, and 24 under conditions that (1) segments S2 and S5 are bit encrypted, whether or not they are also visually scrambled and (2) segments S2 and S5 are visually scrambled but not bit encrypted. The table assumes remote receiving computer 20 has the correct key. (Note, however, that the result of encrypted segments may be unpredictable in some media players.)

| | Displayed | |
|---|---|---|
| | sequence when seg- | Displayed sequence when S2 |
| Computer/ | ments S2 and S5 | and S5 are visually scrambled |
| Media Player | are bit encrypted | but not bit encrypted |
| Computer 20/ | S1, S2, S3, S4, S5 | S1, S2, S3, S4, S5 |
| Media Player 42 | | |
| with correct key | | |
| Computer 22/ | S1, S3, S4 | S1, scrambled S2, S3, S4, |
| Media Player 44 | | scrambled S5 |
| Computer 24/ | S1, unrecognizable | S1, scrambled S2, S3, S4, |
| Media Player 46 | S2, S3, S4, | scrambled S5 |
| | unrecognizable S5 | |

There could be lossy or lossless compression and decompression. By lossless, it is meant the reproduced segments will have the same content in the remote receiving computer they would have had if they had not been protected in the content providing system.

In some embodiments, every block is scrambled. In other embodiments, not every block is scrambled. For example, every fourth block might be scrambled. Header information might not be scrambled. There are several possibilities as to how the fact that video has been scrambled, and which blocks have been scrambled, can be transmitted or conveyed to the media player. The following are some ways.

1. Inserted into a Header Information with the Protected Video.

For MPEG video, the header can be the user data section of the bitstream. The user data section is used specifically for storing any user information and will be ignored by a standard MPEG decoder. A modified MPEG decoder will read the user data section to extract the segment information. In a streaming environment where random access is supported (i.e., video need not be transmitted in full; rather only a small segment of video is transmitted), this segment information may be inserted with the user data section of the segment that are being streamed.

2. Embedded into the Video Frames Using Invisible Watermarking Techniques.

Invisible watermarking techniques are methods for inserting information into media data without creating visible distortion. The media player first extracts the watermark and thus the information regarding protected segment, before actual playback of the video. In a streaming environment where random access is supported, the segment information may be inserted using invisible watermarking techniques to the start of the segment that are being streamed (instead of placing it at the start of the video). In such a case, the video server may be capable of live insertion of the watermark as the video is being streamed to the client.

3. Sending the Information as Separate Data.

This case is useful for online purchase of movie in which unprotected video segments are used as teasers to entice the user to pay for the full movie. Without the protected segment information, the media player cannot play back the protected segment in its original forms. The segment information may be sent only when payment is made and authorization is given.

Bit Encryption

There are various ways in which bit encryption can be perform. Some ways include performing exclusive OR (XOR) operations block by block between a block of the content and another operand that is responsive to a key. The key may include multiple components including, for example, a password, remote computer number, and/or a video position number. The video position number may be a byte number or block number. The key may also include information from previous blocks. There may be multiple levels of XOR operations. The video position number may also be an operand in an XOR operation. In some embodiments, for a first block to be encrypted, the other operand is responsive to a key, and for subsequent blocks to be encrypted, the other operands are blocks of the digital video signal preceding the block to be encrypted. In other embodiments, the operand is always responsive to the key.

Decryption may be performed by the same XOR operations. In decryption, in some embodiments, for a first block to be decrypted, the other operand is responsive to a key, and for subsequent blocks to be decrypted, the other operands are blocks of the decrypted digital video signal preceding the block to be decrypted.

Bit encryption and decryption might be called bit scrambling and descrambling.

Visual Scrambling and Descrambling

In some embodiments, the invention concerns perceptual scrambling of digital signals through altering data (e.g., coefficients) or the order of blocks of data in such that scrambled signal would be partially recognizable and the original digital signal can be recovered through descrambling. Examples of perceptual digital signals are still image signals, motion still image signals (e.g., motion JPEG), graphics signals, and video (moving image) signals, which may include accompanying audio signals. Perceptual degradation refers to the effect an alteration to a perceptual signal would have on the ability of an average person to recognize a scene, object, or sound. With complete perceptual degradation, the scene, object, or sound is completely unrecognizable. With the prior art encryption currently used on video signals by cable broadcasters, there is complete or essentially complete visual perceptual degradation such that if the scene were displayed, it would be completely or essentially completely unrecognizable.

By contrast, the invention involves scrambling of perceptual digital signals with at least some control over the level of perceptual degradation in the scrambled signal, and descrambling the scrambled signal to create a descrambled signal which is identical or very close to the perceptual digital signal before scrambling. In the embodiments described herein, the descrambled signal is identical to the perceptual digital signal before scrambling. However, in other embodiments, there may be some loss so that the recovered perceptual digital signal is not identical to the perceptual digital signal before scrambling.

Visual scrambling may be used to obscure viewing and prevent full-quality copying without authorization. There are numerous uses of the invention. For example, by allowing the user the ability to partially recognize video content, the user may become interested in the content and want to pay money to see the video content in a descrambled form. In some embodiments, the scrambling may be on selected portions of an image so that anyone can view some portions of the images, while only those viewing a descrambled image can view other portions. In still other embodiments, there could be multiple keys used for scrambling and each key would be needed to completely descramble an image.

The invention is not restricted to any particular digital format. However, some embodiments of the invention will be described in connection with MPEG (Moving Picture Experts Group) formats. Current and proposed MPEG formats include MPEG-1 (“Coding of Moving Pictures and Associated Audio for Digital Storage Media at up to about 1.5 MBits/s,” ISO/IEC JTC 1 CD IS-11172 (1992)), MPEG-2 (“Generic Coding of Moving Pictures and Associated Audio,” ISO/IEC JTC 1 CD 13818 (1994); and MPEG-4 (“Very Low Bitrate Audio-Visual Coding” Status: call for Proposals 11.94, Working Draft in 11.96). There are different versions of MPEG-1 and MPEG-2. Various formats other than MPEG may be used.

Referring to FIG. 8, 8×8 pixel sample blocks B0, B1, . . . B7 are taken of a portion of an image in the spatial domain, according to well known techniques. Blocks B0-B3 are included in a first macroblock MB1 and blocks B4-B7 are included in a second macroblock MB2. As is well known, each of blocks B0-B7, may actually include multiple blocks (e.g., red, green, blue RGB blocks). FIG. 9 illustrates an encoder 200 used to encode spatial domain blocks into an MPEG bitstream. Encoder 200 includes motion compensation and estimation mechanism 206, decoder 212, and adder 204 which cooperate to provide spatial domain blocks (intrablock) or difference signals (interblock) from adder 204 to a discrete cosine transform (DCT) quantize and entropy coder mechanism 208 to produce the MPEG bitstream, according to well known techniques. There are various ways in which this can be done, and the invention is not restricted to any particular way. Further, the invention is not restricted to use with MPEG digital video images or a particular MPEG format.

Referring to FIG. 10, the MPEG bitstream of FIG. 9 is represented as an image header, a macroblock header for macroblock MB1, coefficients for macroblock MB1, a macroblock header for macroblock MB2, and coefficients for macroblock MB2. In the DCT domain, MB1 includes DCT blocks B0, B1, B2, and B3, and MB2 includes DCT blocks B4, B5, B6, and B7. Y0 represents luminance coefficients Q0, Q1, . . . Q63 for DCT block B0; Y1 represents luminance coefficients Q0, Q1, . . . Q63 for DCT block B1, . . . ; Y4 represents luminance coefficients Q0, Q1, . . . Q63 for DCT block B4, etc. There are various formats in which some or all chrominance coefficients (U and V) may included. Q0 is a DC coefficient and Q1, Q2, . . . Q63 are referred to as AC coefficients. The DCT is constructed such that energy is concentrated in lower coefficients (e.g., Q1 is a lower coefficient than is Q5). The coefficients include a sign (positive or negative) value. Again, it is noted that the invention is not restricted to use with this particular format.

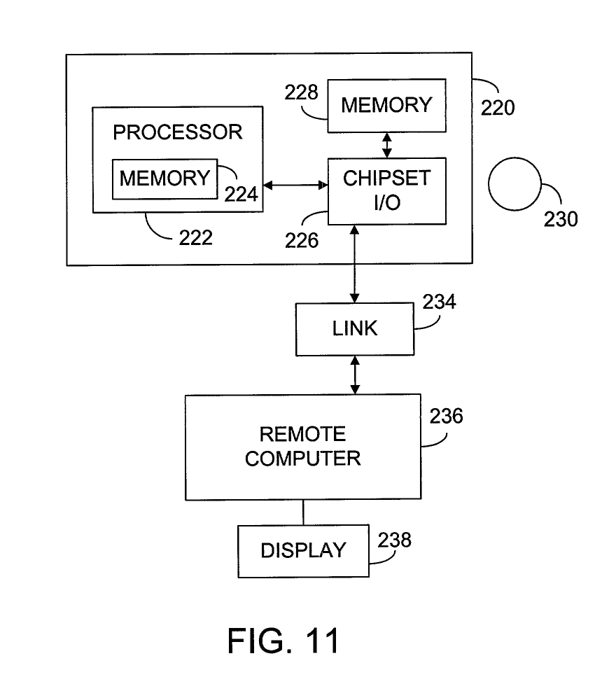

FIG. 11 illustrates a computer 220 (which may be an example of system 14) including a processor 222, on-die memory 224, chipset I/O 226, and off-die memory 228. Memory 222, memory 228, and a disc 228 include machine readable media to hold instructions to be executed and other data. The various block diagram and flow chart blocks in the other figures called mechanisms may represent processor 222 performing functions on software or may represent hardware other than processor 222 performing the functions described in connection with the block diagram or flowchart mechanisms. A link 234 joins computer 220 to a remote computer 236 (which may be an example of remote receiving computer 20). Computer 236 may be the same as of different than computer 220. A display 238 may be packaged with or separate from computer 236. Link 234 represents any of various links including the Internet, an intranet, a local area network, satellite, or other networks. The term computer is intended to be broadly interpreted to include a variety of systems and devices including personal computers, mainframe computers, set top boxes, digital versatile disc (DVD) players, and the like.

Various techniques for visual scrambling of digital images may be used. Two such techniques are coefficient scrambling and permutational scrambling.

1. Coefficient Scrambling and Descrambling

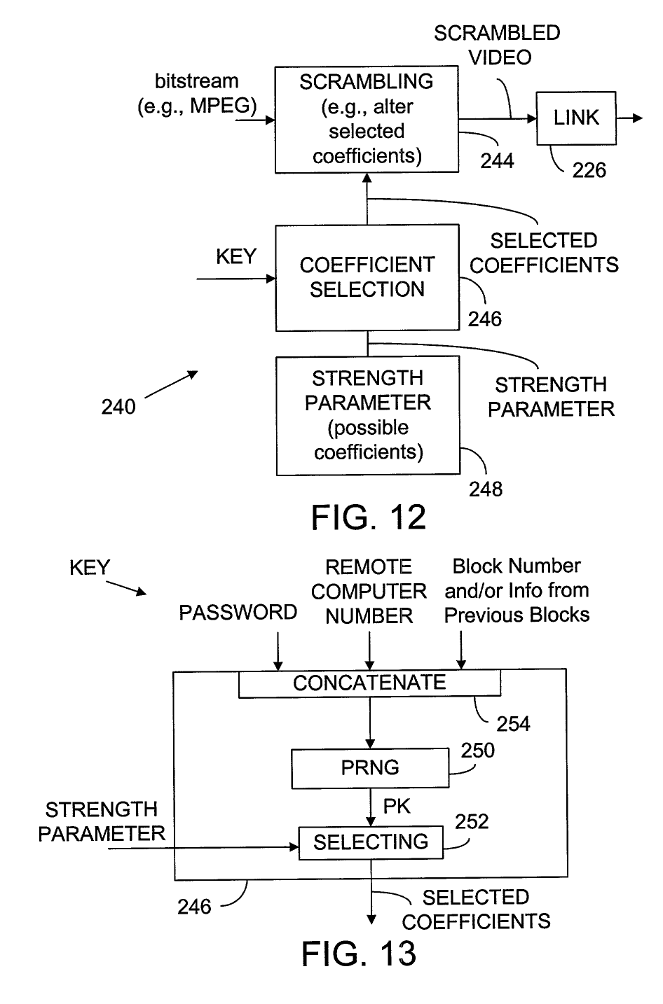

Referring to FIG. 12, a scrambling encoder 240, which may be included in scrambling computer 220 in FIG. 11, includes a scrambling mechanism 244 to scramble a bitstream (e.g., an MPEG bitstream). In some embodiments, scrambling mechanism 244 alters some coefficients of at least some blocks (e.g., in MPEG macroblocks) of the bitstream. Coefficients are an example of data to be altered in scrambling. A block does not have to be a block in a macroblock. It may have a fixed length. In the particular embodiment of FIG. 12, a strength parameter mechanism 248 selects some or all of the coefficients of an MPEG macroblock to be available for altering; but they are not necessarily altered. A strength parameter indicates the coefficients that are available for altering. Responsive to a key, coefficient selection mechanism 246 selects some of the available coefficients to be altered by scrambling mechanism 244. Strength parameter mechanism 248 is not required, but allows control over which coefficients may possibly be altered. The strength parameter may be controllable. Note that there may be circuitry between scrambling mechanism 244 and link 226.

In some embodiments, the coefficients are altered by inverting the sign of selected coefficients. Descrambling can be performed by inverting the signs of the same coefficients to obtain the original values of the coefficients. For example, scrambling may involve changing a coefficient from X to −X and descrambling involve changing the coefficient from −X to X. Coefficients can also be altered through other techniques such as multiplication, division, addition, or subtraction. In some embodiments, only luminance coefficients may be altered. In other embodiments, chrominance coefficients also may be altered. In some embodiments, header data is not altered, but in other embodiments, header data might be altered.

Consider the following example, in which block B0 of FIG. 8 is to be scrambled.

Assume that only luminance coefficients may be altered and that of the total luminance coefficients Q0-Q63, strength parameter mechanism 248 selects a strength parameter indicating that only coefficients Q0-Q20 are available to be altered. Responsive to the key, coefficients selection mechanism 246 selects coefficients Q0, Q1, Q4, Q6, Q8, and Q15 to alter. In that case, scrambling mechanism 244 would alter (e.g., invert the sign of) coefficients Q0, Q1, Q4, Q6, Q8, and Q15 of the luminance coefficients of DCT block B0. In some embodiments, for run/level pairs represented in MPEG's variable length coding (VLC) tables, this may corresponds to inverting only the sign bit; when no codeword exists, the coefficient sign is inverted and the corresponding run/level pair is escape coded as usual.

FIG. 13 illustrates details of some embodiments of coefficients selection mechanism 246. Referring to FIG. 13, a key has multiple components. Examples of possible components include a password, a remote computer number, and a block number and/or information related to previous blocks. Not all of these components are required and there may be additional components. The remote computer number is a number associated with remote receiving computer 236. Examples of remote computer number include a processor number (PN) associated with a particular processor, a chipset number associated with a particular chipset, and a software number that is associated with particular software, such as an operating system, or a combination of them. The remote computer numbers can be obtained in various ways (e.g., through a secure socket layer applet sent to the remote receiving computer). The user of the remote receiving computer could request software that is downloaded from scrambling computer 220 or elsewhere. Upon receiving the correct password, the software interfaces with scrambling computer 220 to provide the remote computer number of the remote receiving computer. Using the remote computer number as a component in the key adds an extra level of security. Computer 220 may act as both scrambling and receiving computer. Remote may be remote in time.

The block number represents the block for which scrambling is to be performed. The block number could be incremented with each block. Information regarding the previous blocks might take the form of a concatenation of some number of coefficient values (e.g., pseudorandomly selected ones of the AC coefficients) from previous blocks. In the illustrated embodiment, the components are concatenated in concatenation mechanism 254 and the concatenated components seed a pseudorandom number generator (PRNG) 250 that creates a processed key (PK). Selecting mechanism 252 selects the coefficients to be altered responsive to the strength parameter and the processed key. The invention is not limited to the details illustrated. For example, additional hashing and truncation may be used.

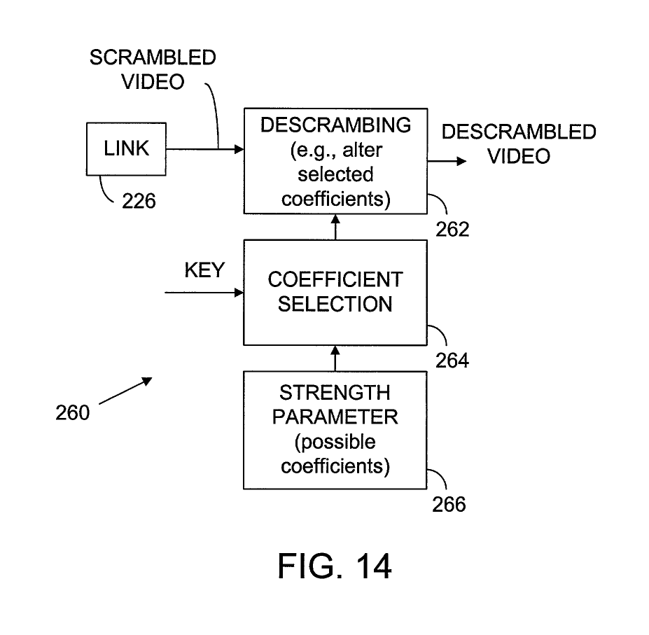

Referring to FIG. 14, a descrambling decoder 260, which may be included in remote receiving computer 236, includes a descrambling mechanism 262 from receiving scrambled video from link 226. (There may be additional circuitry between link 226 and descrambling mechanism 262.) In the example, descrambling mechanism 262 descrambles the scrambled video signal by altering (e.g., inverting the sign of) the coefficients that were altered by scrambling mechanism 244 in FIG. 12. In the example, decoder 260 includes coefficient selection mechanism 264 and strength parameter mechanism 266, which may be the same as coefficient selection mechanism 246 and strength parameter mechanism 248. In such a case, if the same key and strength parameter are used, the same coefficients are selected for alteration as are selected by coefficient selection mechanism 246.

The set of coefficients indicated by the strength parameter controls the maximum possible degradation. The degree of perceptual degradation is related to the coefficients chosen to be altered. For example, if coefficients Q0, Q1, and Q2 are not indicated as being available for being altered, the level of perceptual degradation may on average be less than if coefficients Q0, Q1, and Q2 were available to be altered. One possible choice for the set of available coefficients are those past a given point in the zigzag scan order. This particular choice has the advantage of identifying “significant” coefficients in a manner independent of the scanning order used, which might be desirable if there is a possibility of either MPEG-1 or MPEG-2 having been used for the coding of the video source.

In some embodiments, for intracoded blocks, it may be simpler to only alter AC coefficients (Q1-Q63) and not alter the DC coefficient (Q0). Nevertheless, the DC may be altered. In the case of interceded blocks, AC and DC coefficients may be altered. Nevertheless, the DC coefficients may be altered in more complex implementations. In the case of interceded blocks, AC and DC coefficients may be altered equivalently.

In some embodiments, both MPEG-1 and MPEG-2 encode quantized DCT AC coefficients using a combination of run-length and Huffinan coding, in a manner similar to that of the JPEG (Joint Photographic Experts Group) still image compression standard. Specifically, in some embodiments, non-zero AC coefficients are paired with an associated run of zero values and the combination is encoded using Huffinan coding. The variable-length codeword (VLC) for a run-length/coefficient pair is determined as a function of the magnitude of the non-zero coefficient and the length of the zero run; the sign of the coefficient is encoded as a separate bit of information. In cases where no codeword for a run/level pair exists, the information is coded instead using a fixed-length escape code. The choice of block to be modified is arbitrary, but is typically chosen from intra-coded, nonintra-coded, or either. The degradation in the coded signal can generally be made substantially more severe by modification of intra-coded blocks than is possible by modification of nonintra-coded blocks only, but scrambling of both kinds of blocks is advantageous as the degradation of nonintra-coded blocks can potentially maintain more consistent error propagation throughout the video.

Since both MPEG-1 and MPEG-2 code intra-coded and nonintra-coded blocks using the DCT, both types of blocks may be processed in an identical manner by the scrambling procedure.

The key may be as used in a symmetric key cryptosystem, or may be part of a private/public key pair, depending on the implementation. In the former case, a private key and other parameters could be hashed (e.g. by Secure Hash Algorithm (SHA) or Message Digest 5 (MD-5)) in both the encoder and decoder to generate a pseudorandom sequence. In the latter case, the set of unscrambled AC coefficient values (e.g., signs) might be encrypted with a public key in the encoder and decrypted using the corresponding private key in the decoder. A variety of configurations are possible. The generator should be reseeded periodically to allow random access into the bitstream; for example, the block location could be computed relative to the first block in the current group of pictures (GOP). Furthermore, for greater security, the pseudorandom sequence should be image dependent. One method for achieving this is to make the pseudorandom sequence a function also of the AC values of some subset of DCT blocks in the image or GOP being processed. The pseudorandom sequence is then used to select a subset of coefficients for sign inversion.

Although the invention may be described in terms of encryption and/or decryption, it should be distinguished over the prior art encryption and decryption in which the video is not recognizable unless decrypted and in which there is no control over the level of perceptual degradation.

One result of inverting only the sign of selected coefficients is that the bitrate of the scrambled signal is guaranteed to be identical to that of the input video stream. This fact can be important in cases where bitrate constraints must be maintained and where decoder buffer overflow must be avoided. Furthermore, if only non-zero coefficients are affected by the procedure, the scheme adapts to picture characteristics; high energy regions appear more strongly scrambled than low energy regions.

Although the implementation described is for a single partitioning of coefficients into two sets, the scheme can be easily extended to handle the case where multiple levels of access control are provided for a given block by encrypting disjoint subsets of available coefficients with a unique key for each. In this scenario, the set of keys correctly known by a prospective user determines which of these disjoint coefficient partitions can be correctly decrypted.

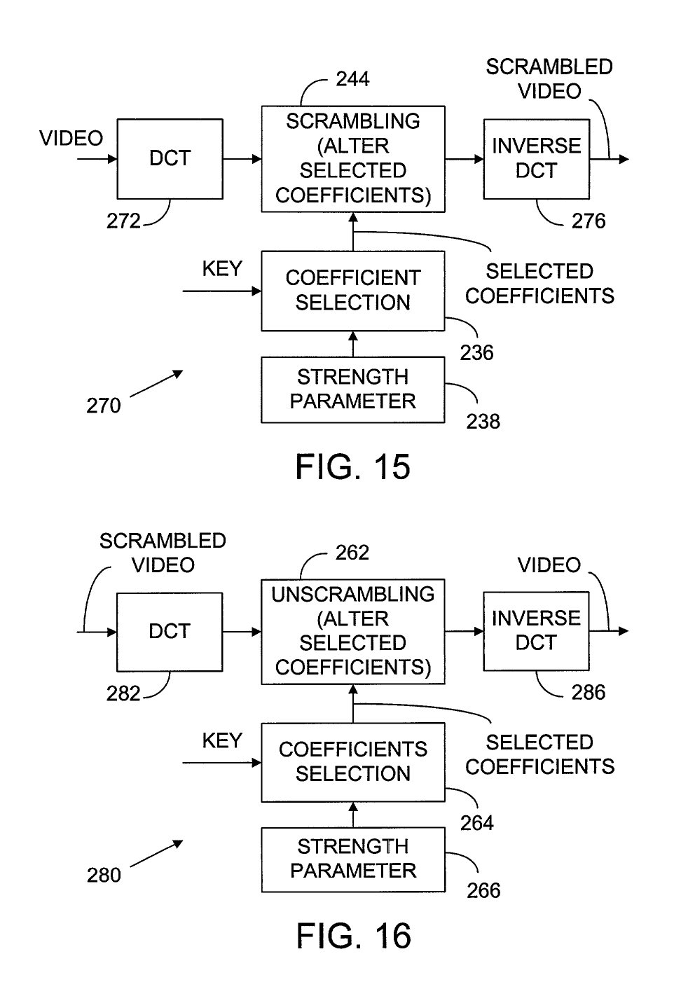

The invention may be used with respect to signals not previously compressed. FIG. 15 illustrates an encode mechanism 270 in which uncompressed (raw) video is first transformed with a DCT mechanism 272 (which may be the same as encoder 200 in FIG. 9). Scrambling mechanism 244 alters the coefficients as described above. An inverse DCT mechanism 276 returns the scrambled video to the uncompressed (raw) video format.

FIG. 16 illustrates a decode mechanism 280 including a DCT mechanism 282 providing transformed signals to descrambling mechanism 262 to descramble the scrambled video produced by encode mechanism 270. An inverse DCT mechanism 286 can restore compressed video.

2. Permutational Scrambling and Descrambling

Another technique for scrambling is to permute the order of blocks of a perceptual digital signal and an other technique for descrambling is to restore the original order of blocks. In different embodiments, the blocks are different. One example of a block is a luminance block within an MPEG macroblock. As described above, each macroblock in both MPEG-1 and MPEG-2 contains up to four coded luminance blocks. For example, in FIG. 10, Y0, Y1, Y2, and Y3 are luminance blocks in DCT macroblock MB1 and Y4, Y5, Y6, and Y7 are luminance blocks in DCT macroblock MB2. For example, assume the group of blocks available for permutation are four luminance blocks (Y0, Y1, Y2, and Y3 in FIG. 10) of a macroblock. There are 4!=24 possible permutations of Y0-Y3 including Y0, Y1, Y3, Y2 and Y0, Y3, Y1, Y2. However, the group of blocks available for permutation may include blocks from more than one macroblock, which greatly increases the number of possible permutations. (Chrominance blocks could also be permuted, but the extra complexity of this procedure might not be worth the effort in most applications due to the eye's relative lack of sensitivity to chrominance information).

As an example, in the case of MPEG video, these blocks may be coded sequentially in the compressed bit stream according to the value of coded_bloc_pattern, which is found in the macroblock header. In an analogous fashion, raw video can be scrambled by permuting the coding order of blocks of raw pixel values.

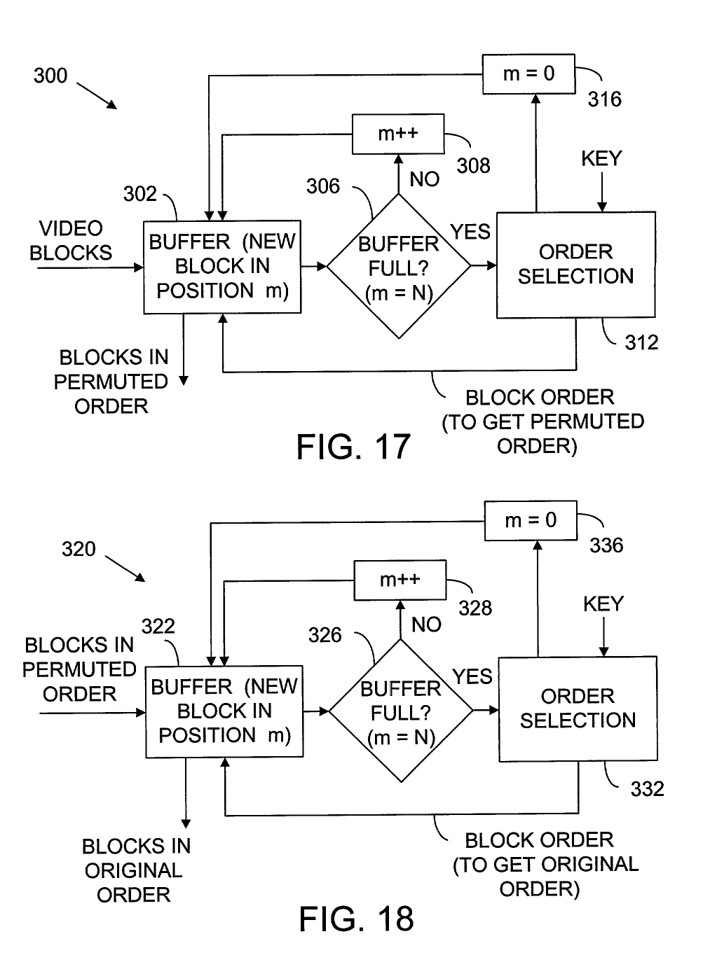

As an example, FIG. 17 illustrates a scrambling encode mechanism 300 (which may be in computer 220 in FIG. 11) in which video blocks (which may be in MPEG format) are received by in buffer 302. In some embodiments, as a block is received, it is identified with a number m or placed in position m of the buffer. The number m is incremented by increment mechanism 308 with each received block until m=N (compare mechanism 306), where N is the number of blocks available for permutation. For example, if a set of four blocks may be permuted, N is 3 (assuming m starts at 0). When m=N, order selection mechanism 312 selects a block order based on a key and sets m to 0. The blocks are read from buffer 302 in the permuted block order as specified in the block order from order selection mechanism 312. The block order may be a mapping for each block, wherein or not it is changed or only those that change order.

FIG. 18 illustrates a descrambling decode mechanism 320 (which may be in computer 236 in FIG. 11) which receives the blocks in permuted order in buffer 322 from buffer 302 in FIG. 17. When the buffer is full (comparison mechanism 326), order selection mechanism 332 selects the block order responsive to a key and buffer 322. Responsive to the block order, the blocks in the original order are read from buffer 322 in the original order. By using the same block order as in FIG. 17, an inverse permutation occurs and the blocks are read out in the original order.

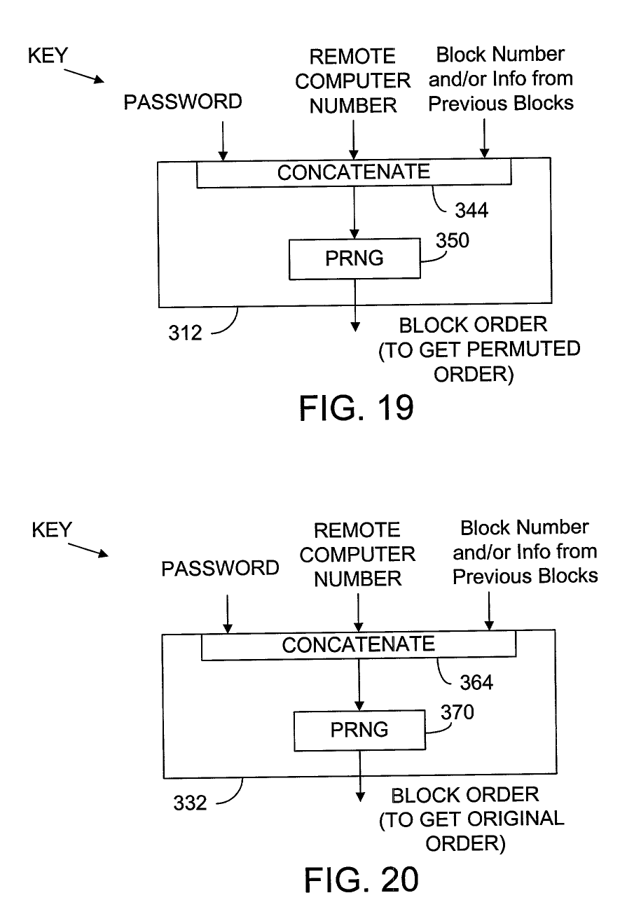

FIG. 19 illustrates details of order selection mechanism 312 according to some embodiments of the invention. The key may include multiple components. Example of the components include a password, computer number, block number and/or information regarding a previous block(s), as described above. Not all of these components are required and others may be included. The components are concatenated in concatenation mechanism 344 and used to seed a PRNG 350 to create the permuted block order. The invention is not restricted to these details. For example, there may be additional hashing and truncation.

FIG. 20 illustrates details of order selection mechanism 332 according to some embodiments of the invention. The same key may be used as in FIG. 19. The key is concatenated by concatenation mechanism 364 and used to seed a PRNG 370 to obtain the block order.

As with DCT coefficient sign inversion, the bitrate of a compressed sequence is unaltered by this approach. Furthermore, if memory requirements are not an issue, a larger number of elements may be involved in each permutation, e.g. blocks within the current slice, as opposed to blocks within the current macroblock, etc. The greater the number of elements operated upon in each permutation, the more substantial is the degradation and the greater is the security found in the scheme.

It is noted that when exchanging blocks, only an array of pointers to the corresponding DCT blocks need be permuted in many cases. This affords a substantial savings in terms of the complexity of the required memory copy operations.

3. Robustness to attack.

It is believed that there is generally insufficient correlation between the signs of AC coefficients in adjacent blocks for an unauthorized user to generate a perceptually good quality version of the scrambled signal when not in possession of the correct key. Attempts to remove the degradation using an incorrect key result in signals exhibiting little apparent change in the perceived visual quality. Furthermore, exploitation of the correlation between the low-frequency AC coefficients of adjacent blocks, which is particularly evidenced in regions exhibiting strong edges, and of the correlation between adjacent video frames, appears to be insufficient for efficient unauthorized generation of a perceptually ‘pleasing’ version of the original signal.

Note that it is not necessary to scramble every block. For example, every fifth block could be scrambled. Or only blocks in a certain portion of an image might be scrambled. There are various ways in which information as to which blocks are scrambled can be conveyed from the scrambling encoder to the descrambling decoder. Examples include including the information in header data (e.g., user data), auxiliary data in a separate signal, hard coded values; watermarking, and other techniques.

There could be multiple levels of scrambling in series using different keys components.

The scrambling and descrambling techniques described herein can be used alone or to complement watermarking and other encryption technology.

While standards such as MPEG-2 incorporate mechanisms such as spatial scalability that can be exploited for such purposes, this introduces additional complexity into the encoding process and can be inappropriate for video sources already stored in the compressed domain. Furthermore, the use of such enhancement layers may not be supported by all decoders, and may not be applicable to MPEG-1 sequences.

Additional Information and Embodiments

It is simplest to make selection mechanisms 312 and 332 identical. Likewise, it is simplest to make scrambling and descrambling encoders and decoders 240 and 260 the same so that the scrambling and descrambling will occur with the same key. It is possible, however, to construct a much more complicated system in which different keys may be used to scramble and descramble. Likewise, it is simplest to make bit encryption and decryption the same, but it is also not required.

The remote receiving computer may be in close proximity to the content providing system. It may be remote in time to the authoring and protecting as well as remote in space.

Reference in the specification to “some embodiments” or “other embodiments” means that a particular feature, structure, or characteristic described in connection with the embodiments is included in at least some embodiments, but not necessarily all embodiments, of the invention. The various appearances of “some embodiments” are not necessarily all referring to the same embodiments.

The term “responsive” and related terms mean that one signal or event is influenced to some extent by another signal or event, but not necessarily completely or directly. If the specification states a component, event, or characteristic “may”, “might” or “could” be included, that particular component, event, or characteristic is not required to be included.

Those skilled in the art having the benefit of this disclosure will appreciate that many other variations from the foregoing description and drawings may be made within the scope of the present invention. Accordingly, it is the following claims including any amendments thereto that define the scope of the invention.

What is claimed is:

1. A method of providing content, comprising:
selecting a set of segments of content from a group of segments to be protected;
protecting the segments of the set with protection that can be undone; and
transmitting the group of segments.

2. The method of claim 1, wherein selecting the set involves selecting at least some of the set for visual scrambling and protecting the set includes visual scrambling those segments selected for visual scrambling.

3. The method of claim 2, wherein visual scrambling involves using a key, including a remote computer number.

4. The method of claim 3, wherein the remote computer number is a processor number.

5. The method of claim 2, wherein selecting the set involves designating those segments to be protected.

6. The method of claim 1, wherein selecting the set involves selecting at least some of the set for bit encryption and protecting the set includes bit encrypting those segments selected for bit encryption.

7. The method of claim 1, wherein selecting the set involves selecting at least some of the set for visual scrambling and at least some of the set for bit encryption, wherein some of the set may be selected for both visual scrambling and bit encryption, and protecting the set includes visual scrambling those segments selected for visual scrambling and bit encrypting those segments selected for bit encryption.

8. The method of claim 1, wherein a remote computer number is stored and matched against a remote computer number from a remote receiving computer during playback.

9. The method of claim 1, wherein prior to protection, the segments include video signals.

10. The method of claim 8, wherein the video signals are in an MPEG format.

11. The method of claim 1, wherein prior to protection, the segments include video and audio and both the video and audio are protected.

12. A method of receiving and processing content, comprising:
receiving a group of segments of content;
identifying a set of segments in the group that are protected if a correct key is received;
undoing the protection; and
playing the group of segments seamlessly with a media player.

13. The method of claim 12, wherein identifying the protected segments involves identifying segments that have been visually scrambled.

14. The method of claim 12, wherein identifying the protected segments involves identifying segments that have been bit encrypted.

15. The method of claim 12, wherein the key includes a remote computer number.

16. The method of claim 12, wherein information identifying protected segments is contained in headers.

17. The method of claim 12, wherein information identifying protected segments is contained in at least one watermark.

18. The method of claim 12, wherein information identifying protected segments is contained in data transmitted separately from the segments.

19. A content providing system, comprising:
storage to hold content divided into segments;
a user interface; and
circuitry and software cooperating with the user interface to select a set of the segments to be protected and to protect the set of segments.

20. The content providing system of claim 19, wherein protecting the selected segments involves a key including a remote computer number.

21. The content providing system of claim 19, wherein the user interface includes options to select at least some of the set of segments to be visually scrambling and the protecting of the segments selected for visual scrambling includes visual scrambling.

22. The content providing system of claim 19, wherein the user interface includes options to select at least some of the set of segments to be bit encrypted and protecting of the segments selected for bit encryption includes bit encryption.

23. The content providing system of claim 19, wherein the user interface includes options to select at least some of the set of segments to be visually scrambled and at least some of the set of segments to be bit encrypted, wherein some of the set of segments may be selected for both visual scrambling and bit encryption, and protecting of the segments selected for visual scrambling includes visual scrambling and protecting of the segments selected for bit encryption includes bit encryption.

24. The content providing system of claim 19, wherein the content includes video signals.

25. The content providing system of claim 19, wherein the content includes video signals and audio signals.

26. An article comprising:
a machine readable media including instructions that when executed cause a content providing system to:
select a set of segments of content from a group of segments to be protected;
protect the segments of the set with protection that can be undone; and
transmit the group of segments.

27. The article of claim 26, wherein protecting the selected segments involves a key including a remote computer number.

28. An article comprising:
a machine readable media including instructions that when executed cause a content providing system to:
receive a group of segments of content;
identify a set of segments in the group that are protected;
undo the protection; and
play the group of segments seamlessly with a media player.

29. The article of claim 28, wherein undoing the protecting of the selected segments involves a key including a remote computer number.
